(19) United States
(12) Patent Application Publication
(10) Pub. No.: US 2023/0250362 A1
(43) Pub. Date: Aug. 10, 2023

(54) METHOD OF LAUNDERING FABRIC

(71) Applicant: The Procter & Gamble Company, Cincinnati, OH (US)

(72) Inventors: Alan Thomas BROOKER, NEWCASTLE UPON TYNE (GB); Anna CELMINA, EDINBURGH (GB); Sarah Jane DOUGLASS, NEWCASTLE UPON TYNE (GB); Linsey Sarah FULLER, NEWCASTLE UPON TYNE (GB); Gregory Scot MIRACLE, LIBERTY TOWNSHIP, OH (US); Robert William John STERRY, NEWCASTLE UPON TYNE (GB); Aaron Ryan Wawell Tiu SY, BEIJING (CN)

(21) Appl. No.: 18/107,094

(22) Filed: Feb. 8, 2023

(30) Foreign Application Priority Data
Feb. 8, 2022 (WO) PCT/CN2022/075459

(51) Int. Cl. C11D 1/83; C11D 11/00; C11D 3/00; C11D 3/42; C11D 3/50; C11D 3/39; C11D 3/395; C11D 3/20; C11D 3/26; C11D 3/30

(52) U.S. Cl. CPC C11D 1/83; C11D 11/0017; C11D 3/0084; C11D 3/42; C11D 3/50; C11D 3/3942; C11D 3/3951; C11D 3/3955; C11D 3/2093; C11D 3/26; C11D 3/30; C11D 1/26

(57) ABSTRACT

A method of laundering fabric including the steps of: (a) contacting a detergent composition including: (i) detersive surfactant; (ii) phenolic antioxidant (iii) percarbonate; (iv) optionally, a bleach activator capable of forming C₁-C₁₁ alkyl substituted peroxycarboxylic acid; and (iv) hueing dye, with water to form a wash liquor including from 60 ppm to 2750 ppm detersive surfactant, from 0.1 ppm to 200 ppm phenolic antioxidant, from 10 ppm to 3000 ppm percarbonate, optionally from 2 ppm to 1000 ppm bleach activator, and from 0.005 to 500 pm hueing dye, and from 0.001 ppm to 10.0 ppm iron, and having a pH in the range of from greater than 7.0 to 12.0; (b) contacting fabric with the wash liquor; and (c) laundering the fabric.

### FIELD OF THE INVENTION

The present invention relates to a method of laundering fabric. The method comprises the steps of: (a) contacting a detergent composition comprising: (i) detersive surfactant; (ii) phenolic antioxidant (iii) percarbonate; (iv) optionally, a bleach activator capable of forming C₁-C₁₁ alkyl substituted peroxycarboxylic acid; and (iv) hueing dye, with water to form a wash liquor comprising from 60 ppm to 2750 ppm detersive surfactant, from 0.1 ppm to 200 ppm phenolic antioxidant, from 10 ppm to 3000 ppm percarbonate, optionally from 2 ppm to 1000 ppm bleach activator, and from 0.005 to 500 pm hueing dye, and from 0.001 ppm to 10.0 ppm iron, and having a pH in the range of from greater than 7.0 to 12.0; (b) contacting fabric with the wash liquor; and (c) laundering the fabric.

### BACKGROUND OF THE INVENTION

Whiteness and stain removal cleaning performance is desired by consumers. Laundry detergent manufacturers formulate ingredients such as percarbonate (bleach) and hueing dye to achieve good cleaning performance. However, percarbonate based bleach systems can negatively affect the hueing dye performance. The capacity of the percarbonate based bleach system needs to be carefully controlled (and limited) when hueing dye is present, so as to not negatively affect the whiteness performance of the hueing dye.

The inventors have surprisingly found that the addition of specific phenolic antioxidant into a laundry detergent that comprises percarbonate and hueing dye, decreases the reactivity between the percarbonate and the hueing dye. This in turn enables a greater capacity of percarbonate to be used in the presence of hueing dye without having a detrimental effect on the hueing dye performance.

### SUMMARY OF THE INVENTION

The present invention provides a method of laundering fabric comprising the steps of:
(a) contacting a detergent composition comprising:
   (i) detersive surfactant;
   (ii) phenolic antioxidant having the structure

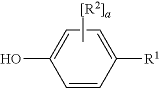

wherein the index a is 1 or 2,
wherein when a is 1, R² is t-butyl and R¹ is —OCH₃,
wherein when a is 2, one R² is t-butyl and the other R² is selected from t-butyl and methyl,
wherein, when a is 2 at least one R² group must be ortho to the hydroxyl group, preferably a t-butyl,
wherein R¹ is selected from the group consisting of methyl, t-butyl, and (C_{b}H_{2b})C(O)R³, where the index b is 2 or 3, preferably 2,
wherein R³ is selected from the group consisting of:
(i) OR⁴ where R⁴ is selected from C₁-C₁₈ linear or branched alkyl; —O-Q-O-G, where Q is selected from the group consisting of:
   C₂-C₈ linear or branched alkylene, optionally containing therein one or more ether, thioether or oxamide groups;

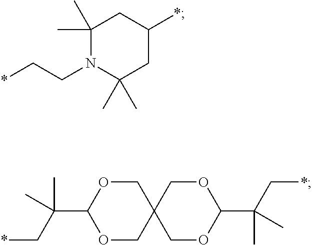

and
any combination thereof;
(ii)

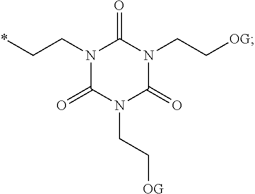

(iii)

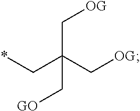

and
(iv) any combination thereof;
wherein each G is independently selected from the group consisting of H and

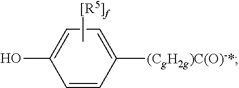

wherein f is 1 or 2,
wherein when f is 1, R⁵ is t-butyl,
wherein when f is 2, one R⁵ is t-butyl and the other R⁵ is selected from t-butyl and methyl,
wherein when f is 2, at least one R⁵ group must be ortho to the hydroxyl group, preferably a t-butyl,
wherein g is 2 or 3, preferably 2,
wherein f, g, and R⁵ are independently selected for each G group;
(iii) percarbonate; and
(iv) hueing dye,
with water to form a wash liquor comprising from 60 ppm to 2750 ppm detersive surfactant, from 0.1 ppm to 200 ppm phenolic antioxidant, from 10 ppm to 3000 ppm percarbonate, and from 0.005 to 500 pm hueing dye, and from 0.001 ppm to 10.0 ppm iron, and having a pH in the range of from greater than 7.0 to 12.0;
(b) contacting fabric with the wash liquor; and
(c) laundering the fabric.

### DETAILED DESCRIPTION OF THE INVENTION

### Method of Laundering Fabric

The method comprises the steps of: (a) contacting a detergent composition comprising: (i) detersive surfactant; (ii) phenolic antioxidant (iii) percarbonate; (iv) optionally, a bleach activator capable of forming C₁-C₁₁ alkyl substituted peroxycarboxylic acid; and (iv) hueing dye, with water to form a wash liquor comprising from 60 ppm to 2750 ppm detersive surfactant, from 0.1 ppm to 200 ppm phenolic antioxidant, from 10 ppm to 3000 ppm percarbonate, optionally from 2 ppm to 1000 ppm bleach activator, and from 0.005 to 500 pm hueing dye, and from 0.001 ppm to 10.0 ppm iron, and having a pH in the range of from greater than 7.0 to 12.0; (b) contacting fabric with the wash liquor; and (c) laundering the fabric.

The method typically involves a drying step, usually after step (c). Suitable drying steps include line drying and machine drying (tumble-drying).

### Step (a)

Step (a) contacts a detergent composition with water to form a wash liquor.

### Step (b)

Step (b) contacts fabric with the wash liquor.

### Step (c)

Step (c) launders the fabric.

### Wash Liquor

The wash liquor formed during step (a) comprises from 60 ppm to 2750 ppm detersive surfactant, from 0.1 ppm to 200 ppm phenolic antioxidant, from 10 ppm to 3000 ppm percarbonate, optionally from 0 ppm to 1000 ppm or from 2 ppm to 1000 ppm bleach activator, and from 0.005 to 500 pm hueing dye, and from 0.001 ppm to 10.0 ppm iron, and having a pH in the range of from greater than 7.0 to 12.0.

The wash liquor has a pH in the range of from greater than 7.0 to 12.0. The wash liquor may have a pH of from 10.0 to 12.0. Alternatively, the wash liquor may have a pH of from above 7.0 to less than 10.0.

The detersive surfactant preferably comprises C₁₂-C₁₄ alkyl sulphate detersive surfactant.

The wash liquor may comprise from 0.2 ppm to 200 ppm perfume.

The wash liquor may comprise from 0.4 ppm to 160 ppm enzyme.

The wash liquor may comprise from 0.001 ppm to 20 ppm acyl hydrazone bleach catalyst.

The wash liquor may comprise from 0.001 ppm to 20 ppm imine-based or iminium-based bleach catalyst.

The wash liquor may comprise from 0.001 ppm to 20 ppm transition metal catalyst.

The wash liquor may comprise from 0.001 ppm to 1600 ppm bleach activator.

The wash liquor may comprise from 0.001 ppm to 2000 ppm pre-formed peracid.

The wash liquor may comprise from 0.001 ppm to 200 ppm hueing dye, wherein the hueing dye is preferably selected from azo dye, azine dye, anthroquinone dye, and any combination thereof.

### Phenolic Antioxidant

The phenolic antioxidant has the structure:

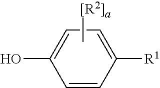

wherein the index a is 1 or 2,
wherein when a is 1, R² is t-butyl and R¹ is —OCH₃,
wherein when a is 2, one R² is t-butyl and the other R² is selected from t-butyl and methyl,
wherein, when a is 2 at least one R² group must be ortho to the hydroxyl group, preferably a t-butyl,
wherein R¹ is selected from the group consisting of methyl, t-butyl, and (C_{b}H_{2b})C(O)R³, where the index b is 2 or 3, preferably 2,
wherein R³ is selected from the group consisting of:
(i) OR⁴ where R⁴ is selected from C₁-C₁₈ linear or branched alkyl; —O-Q-O-G, where Q is selected from the group consisting of:
   C₂-C₈ linear or branched alkylene, optionally containing therein one or more ether, thioether or oxamide groups;

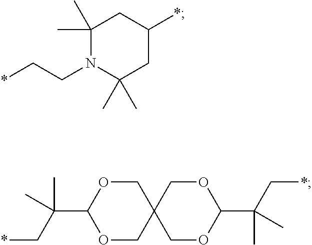

and
any combination thereof;
(ii)

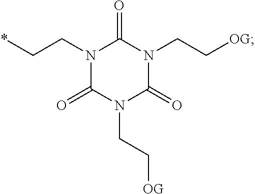

(iii)

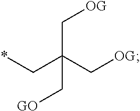

and
(iv) any combination thereof;
wherein each G is independently selected from the group consisting of H and

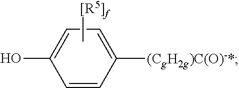

wherein f is 1 or 2,
wherein when f is 1, R⁵ is t-butyl,
wherein when f is 2, one R⁵ is t-butyl and the other R⁵ is selected from t-butyl and methyl,
wherein when f is 2, at least one R⁵ group must be ortho to the hydroxyl group, preferably a t-butyl,
wherein g is 2 or 3, preferably 2,
wherein f, g, and R⁵ are independently selected for each G group,
with water to form a wash liquor comprising from 50 ppm to 2000 ppm linear alkylbenzene sulphonate detersive surfactant and from 10 to 750 ppm C₈-C₂₄ alkyl sulphate, from 0.1 ppm to 200 ppm phenolic antioxidant and from 0.001 ppm to 10.0 ppm iron, and having a pH in the range of from greater than 7.0 to 12.0, and wherein the molar ratio of linear alkylbenzene sulphonate detersive surfactant to C₈-C₂₄ alkyl sulphate detersive surfactant present in the wash liquor is in the range of from 0.05 to 200;
(b) contacting fabric with the wash liquor; and
(c) laundering the fabric.

Preferably, the phenolic antioxidant has a structure selected from:

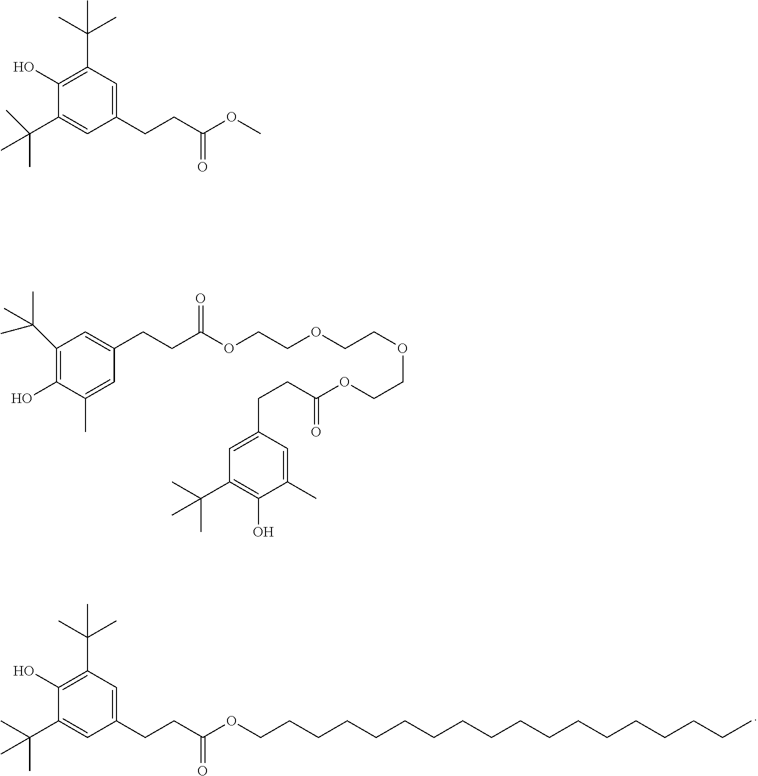 [SMILES: COC(=O)CCc1cc(C(C)(C)C)c(O)c(C(C)(C)C)c1 ; Cc1cc(CCC(=O)OCCOCCOCCOC(=O)CCc2cc(C)c(O)c(C(C)(C)C)c2)cc(C(C)(C)C)c1O ; CCCCCCCCCCCCCCCCCCOC(=O)CCc1cc(C(C)(C)C)c(O)c(C(C)(C)C)c1]

Most preferably, the phenolic antioxidant is octadecyl di-t-butyl-4-hydroxyhydrocinnamate.

A suitable phenolic antioxidant is Tinogard TS®.

Typically, commercial sources of suitable phenolic antioxidants comprise low levels of impurities such as esters, alcohols, carboxylic acids and the like. Such impurities are usually present due to by-products of synthesis reactions or form during storage of the phenolic antioxidant. Such impurities do not affect the performance of the phenolic antioxidant.

### Detergent Composition

The detergent composition may comprise perfume.

The detergent composition may comprise enzyme.

The detergent composition may comprise acyl hydrazone bleach catalyst.

The detergent composition may comprise imine-based or iminium-based bleach catalyst.

The detergent composition may comprise a transition metal catalyst.

The detergent composition may comprise bleach activator selected from tetraacetyl ethylenediamine and/or nonanoyl oxybenzene sulphonate.

The detergent composition may comprise pre-formed peracid, preferably phthalimidoperoxycaproic acid.

The detergent composition may comprise hueing dye selected from azo dye, azine dye, anthroquinone dye, and any combination thereof.

The detergent composition can be in any form. Suitable forms are solid and liquid. The detergent composition is preferably a powder laundry detergent composition, this can include a laundry detergent bead. The detergent composition can be a liquid laundry detergent composition, this can include a gel laundry detergent composition. The detergent composition can also be a unit dose laundry detergent composition, such as a laundry detergent pouch or a laundry detergent tablet. The laundry detergent composition can be a laundry detergent sheet.

Preferably, the laundry detergent composition is a solid free-flowing particulate laundry detergent composition. Preferably, the detergent composition is a fully formulated laundry detergent composition, not a portion thereof such as a spray-dried, extruded or agglomerate particle that only forms part of the laundry detergent composition. Typically, the detergent composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Suitable laundry detergent compositions comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; brighteners; chelants; hueing agents; dye transfer inhibitors; dye fixative agents; perfume; silicone; fabric softening agents, such as clay; flocculants, such as polyethyleneoxide; suds supressors; and any combination thereof.

Suitable laundry detergent compositions may have a low buffering capacity. Such laundry detergent compositions typically have a reserve alkalinity to pH 9.5 of less than 5.0 g NaOH/100 g. These low buffered laundry detergent compositions typically comprise low levels of carbonate salt.

Detersive Surfactant: Suitable detersive surfactants include anionic detersive surfactants, non-ionic detersive surfactant, cationic detersive surfactants, zwitterionic detersive surfactants and amphoteric detersive surfactants. Suitable detersive surfactants may be linear or branched, substituted or un-substituted, and may be derived from petrochemical material or biomaterial.

Anionic detersive surfactant: Suitable anionic detersive surfactants include sulphonate and sulphate detersive surfactants.

Suitable sulphonate detersive surfactants include methyl ester sulphonates, alpha olefin sulphonates, alkyl benzene sulphonates, especially alkyl benzene sulphonates, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 5, more preferably from 0.5 to 3 and most preferably from 0.5 to 1.5.

The alkyl sulphate, alkyl alkoxylated sulphate and alkyl benzene sulphonates may be linear or branched, substituted or un-substituted, and may be derived from petrochemical material or biomaterial.

Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counter-ion is sodium.

Non-ionic detersive surfactant: Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic detersive surfactants are alkylpolyglucoside and/or an alkyl alkoxylated alcohol.

Suitable non-ionic detersive surfactants include alkyl alkoxylated alcohols, preferably C₈₋₁₈ alkyl alkoxylated alcohol, preferably a C₈₋₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable nonionic detersive surfactants include secondary alcohol-based detersive surfactants.

Cationic detersive surfactant: Suitable cationic detersive surfactants include alkyl pyridinium compounds, alkyl quaternary ammonium compounds, alkyl quaternary phosphonium compounds, alkyl ternary sulphonium compounds, and mixtures thereof.

Preferred cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.

Zwitterionic detersive surfactant: Suitable zwitterionic detersive surfactants include amine oxides and/or betaines.

Polymer: Suitable polymers include carboxylate polymers, soil release polymers, anti-redeposition polymers, cellulosic polymers, care polymers and any combination thereof.

Carboxylate polymer: The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Another suitable carboxylate polymer is a co-polymer that comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

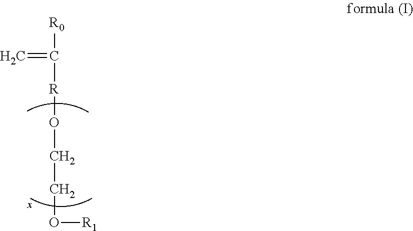

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

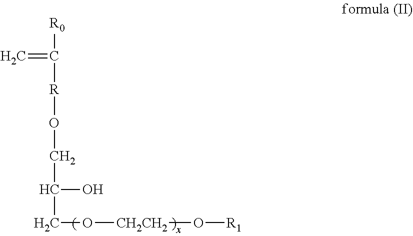

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

It may be preferred that the polymer has a weight average molecular weight of at least 50 kDa, or even at least 70 kDa.

Soil release polymer: The composition may comprise a soil release polymer. A suitable soil release polymer has a structure as defined by one of the following structures (I), (II) or (III):

[(OCHR¹—CHR²)ₐ—O—OC—Ar—CO—]_{d} (I)

[(OCHR³—CHR⁴)_{b}—O—OC-sAr—CO—]ₑ (II)

—[OCHR⁵—CHR⁶)_{c}—OR⁷]_{f} (III)

wherein:
a, b and c are from 1 to 200;
d, e and f are from 1 to 50;
Ar is a 1,4-substituted phenylene;
sAr is 1,3-substituted phenylene substituted in position 5 with SO₃Me; Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof; R¹, R², R³, R⁴, R⁵ and R⁶ are independently selected from H or C₁-C₁₈ n- or iso-alkyl; and
R⁷ is a linear or branched C₁-C₁₅ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.
Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

Anti-redeposition polymer: Suitable anti-redeposition polymers include polyethylene glycol polymers and/or polyethyleneimine polymers.

Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide unit can be less than 0.02, or less than 0.016, the average number of graft sites per ethylene oxide unit can be in the range of from 0.010 to 0.018, or the average number of graft sites per ethylene oxide unit can be less than 0.010, or in the range of from 0.004 to 0.008.

Suitable polyethylene glycol polymers are described in WO08/007320.

A suitable polyethylene glycol polymer is Sokalan HP22.

Cellulosic Polymer: Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof.

Suitable carboxymethyl celluloses have a degree of carboxymethyl substitution from 0.5 to 0.9 and a molecular weight from 100,000 Da to 300,000 Da.

Suitable carboxymethyl celluloses have a degree of substitution greater than 0.65 and a degree of blockiness greater than 0.45, e.g. as described in WO09/154933.

Care Polymers: Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose.

Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis).

Other suitable care polymers include amino-silicone, which can provide fabric feel benefits and fabric shape retention benefits.

Bleach: Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst.

Source of hydrogen peroxide: Suitable sources of hydrogen peroxide include sodium perborate and/or sodium percarbonate.

Bleach Activator: Suitable bleach activators include tetra acetyl ethylene diamine and/or alkyl oxybenzene sulphonate.

Bleach Catalyst: The composition may comprise a bleach catalyst. Suitable bleach catalysts include oxaziridinium bleach catalysts, transition metal bleach catalysts, especially manganese and iron bleach catalysts. A suitable bleach catalyst has a structure corresponding to general formula below:

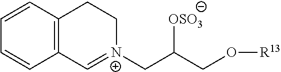

wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

Pre-formed Peracid: Suitable pre-form peracids include phthalimido-peroxycaproic acid.

Enzymes: Suitable enzymes include lipases, proteases, cellulases, amylases and any combination thereof.

Protease: Suitable proteases include metalloproteases and/or serine proteases. Examples of suitable neutral or alkaline proteases include: subtilisins (EC 3.4.21.62); trypsin-type or chymotrypsin-type proteases; and metalloproteases. The suitable proteases include chemically or genetically modified mutants of the aforementioned suitable proteases.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Preferenz P® series of proteases including Preferenz® P280, Preferenz® P281, Preferenz® P2018-C, Preferenz® P2081-WE, Preferenz® P2082-EE and Preferenz® P2083-A/J, Properase®, Purafect®, Purafect Prime®, Purafect Ox®, FN3®, FN4®, Excellase® and Purafect OXP® by DuPont, those sold under the tradename Opticlean® and Optimase® by Solvay Enzymes, those available from Henkel/Kemira, namely BLAP (sequence shown in FIG. 29 of U.S. Pat. No. 5,352,604 with the folowing mutations S99D+S101 R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D)—all from Henkel/Kemira; and KAP (Bacillus alkalophilus subtilisin with mutations A230V+S256G+S259N) from Kao.

A suitable protease is described in WO11/140316 and WO11/072117.

Amylase: Suitable amylases are derived from AA560 alpha amylase endogenous to Bacillus sp. DSM 12649, preferably having the following mutations: R118K, D183*, G184*, N195F, R320K, and/or R458K. Suitable commercially available amylases include Stainzyme®, Stainzyme® Plus, Natalase, Termamyl®, Termamyl® Ultra, Liquezyme® SZ, Duramyl®, Everest® (all Novozymes) and Spezyme® AA, Preferenz S® series of amylases, Purastar® and Purastar® Ox Am, Optisize® HT Plus (all Du Pont).

A suitable amylase is described in WO06/002643.

Cellulase: Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, Carezyme®, and Carezyme® Premium, Celluclean® and Whitezyme® (Novozymes A/S), Revitalenz® series of enzymes (Du Pont), and Biotouch® series of enzymes (AB Enzymes). Suitable commercially available cellulases include Carezyme® Premium, Celluclean® Classic. Suitable cellulases are described in WO07/144857 and WO10/056652.

Lipase: Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

The lipase may be a “first cycle lipase”, e.g. such as those described in WO06/090335 and WO13/116261. In one aspect, the lipase is a first-wash lipase, preferably a variant of the wild-type lipase from Thermomyces lanuginosus comprising T231R and/or N233R mutations. Preferred lipases include those sold under the tradenames Lipex®, Lipolex® and Lipoclean® by Novozymes, Bagsvaerd, Denmark.

Other suitable lipases include: Liprl 139, e.g. as described in WO2013/171241; and TfuLip2, e.g. as described in WO2011/084412 and WO2013/033318.

Other Enzymes: Other suitable enzymes are bleaching enzymes, such as peroxidases/oxidases, which include those of plant, bacterial or fungal origin and variants thereof. Commercially available peroxidases include Guardzyme® (Novozymes A/S). Other suitable enzymes include choline oxidases and perhydrolases such as those used in Gentle Power Bleach™.

Other suitable enzymes include pectate lyases sold under the tradenames X-Pect®, Pectaway® (from Novozymes A/S, Bagsvaerd, Denmark) and PrimaGreen® (DuPont) and mannanases sold under the tradenames Mannaway® (Novozymes A/S, Bagsvaerd, Denmark), and Mannastar® (Du Pont).

Zeolite Builder: The composition may comprise zeolite builder. The composition may comprise from 0 wt % to 5 wt % zeolite builder, or 3 wt % zeolite builder. The composition may even be substantially free of zeolite builder; substantially free means “no deliberately added”. Typical zeolite builders include zeolite A, zeolite P and zeolite MAP.

Phosphate Builder: The composition may comprise phosphate builder. The composition may comprise from 0 wt % to 5 wt % phosphate builder, or to 3 wt %, phosphate builder. The composition may even be substantially free of phosphate builder; substantially free means “no deliberately added”. A typical phosphate builder is sodium tri-polyphosphate.

Carbonate Salt: The composition may comprise carbonate salt. The composition may comprise from 0 wt % to 10 wt % carbonate salt, or to 5 wt % carbonate salt. The composition may even be substantially free of carbonate salt; substantially free means “no deliberately added”.

Suitable carbonate salts include sodium carbonate and sodium bicarbonate.

Silicate Salt: The composition may comprise silicate salt. The composition may comprise from 0 wt % to 10 wt % silicate salt, or to 5 wt % silicate salt. A preferred silicate salt is sodium silicate, especially preferred are sodium silicates having a Na₂O:SiO₂ ratio of from 1.0 to 2.8, preferably from 1.6 to 2.0.

Sulphate Salt: A suitable sulphate salt is sodium sulphate.

Brightener: Suitable fluorescent brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN.

Preferred brighteners are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)];amino}stilbene-2-2′ disulfonate, disodium 4,4′-bis{[(4-anilino-6-morpholino-1,3,5-triazin-2-yl)]amino} stilbene-2-2′ disulfonate, and disodium 4,4′-bis(2-sulfostyryl)biphenyl. A suitable fluorescent brightener is C.I. Fluorescent Brightener 260, which may be used in its beta or alpha crystalline forms, or a mixture of these forms.

Chelant: The composition may also comprise a chelant selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). The composition preferably comprises ethylene diamine-N′N′-disuccinic acid or salt thereof. Preferably the ethylene diamine-N′N′-disuccinic acid is in S,S enantiomeric form. Preferably the composition comprises 4,5-dihydroxy-m-benzenedisulfonic acid disodium salt. Preferred chelants may also function as calcium carbonate crystal growth inhibitors such as: 1-hydroxyethanediphosphonic acid (HEDP) and salt thereof; N,N-dicarboxymethyl-2-aminopentane-1,5-dioic acid and salt thereof; 2-phosphonobutane-1,2,4-tricarboxylic acid and salt thereof; and combination thereof.

Hueing Agent: Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13 and any combination thereof.

Many hueing agents are known and described in the art which may be suitable for the present invention, such as hueing agents described in WO2014/089386.

Suitable hueing agents include phthalocyanine and azo dye conjugates, such as described in WO2009/069077.

Suitable hueing agents may be alkoxylated. Such alkoxylated compounds may be produced by organic synthesis that may produce a mixture of molecules having different degrees of alkoxylation. Such mixtures may be used directly to provide the hueing agent, or may undergo a purification step to increase the proportion of the target molecule. Suitable hueing agents include alkoxylated bis-azo dyes, such as described in WO2012/054835, and/or alkoxylated thiophene azo dyes, such as described in WO2008/087497 and WO2012/166768.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route. Suitable hueing agents can be incorporated into hueing dye particles, such as described in WO 2009/069077.

Dye Transfer Inhibitors: Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP-K15 and K30 (Ashland), Sokalan® HP165, HP50, HP53, HP59, HP56K, HP56, HP66 (BASF), Chromabond® S-400, S403E and S-100 (Ashland).

Perfume: Suitable perfumes comprise perfume materials selected from the group: (a) perfume materials having a C log P of less than 3.0 and a boiling point of less than 250° C. (quadrant 1 perfume materials); (b) perfume materials having a C log P of less than 3.0 and a boiling point of 250° C. or greater (quadrant 2 perfume materials); (c) perfume materials having a C log P of 3.0 or greater and a boiling point of less than 250° C. (quadrant 3 perfume materials); (d) perfume materials having a C log P of 3.0 or greater and a boiling point of 250° C. or greater (quadrant 4 perfume materials); and (e) mixtures thereof.

It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof. A suitable perfume microcapsule is described in WO2009/101593.

Silicone: Suitable silicones include polydimethylsiloxane and amino-silicones. Suitable silicones are described in WO05075616.

Process for Making the Solid Composition: Typically, the particles of the composition can be prepared by any suitable method. For example: spray-drying, agglomeration, extrusion and any combination thereof.

Typically, a suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

Typically, the spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10 wt % of the spray-dried particles have a particle size greater than 2360 micrometers.

It may be preferred to heat the aqueous slurry mixture to elevated temperatures prior to atomization into the spray-drying tower, such as described in WO2009/158162.

It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump, such as described in WO 09/158449.

It may be preferred for a gas, such as air, to be introduced into the spray-drying process after the step of forming the aqueous slurry, such as described in WO2013/181205.

It may be preferred for any inorganic ingredients, such as sodium sulphate and sodium carbonate, if present in the aqueous slurry mixture, to be micronized to a small particle size such as described in WO2012/134969.

Typically, a suitable agglomeration process comprises the step of contacting a detersive ingredient, such as a detersive surfactant, e.g. linear alkyl benzene sulphonate (LAS) and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as LAS, is contacted with an alkaline material, such as carbonate and/or sodium hydroxide, in a mixer, and wherein the acid precursor of a detersive surfactant is neutralized by the alkaline material to form a detersive surfactant during the agglomeration process.

Other suitable detergent ingredients that may be agglomerated include polymers, chelants, bleach activators, silicones and any combination thereof.

The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process.

It may be preferred for the agglomerates to be subjected to a drying step, for example to a fluid bed drying step. It may also be preferred for the agglomerates to be subjected to a cooling step, for example a fluid bed cooling step.

Typically, the agglomerates are subjected to particle size classification, for example a fluid bed elutriation and/or a sieve, to obtain the desired particle size distribution. Preferably, the agglomerates have a particle size distribution such that weight average particle size is in the range of from 300 micrometers to 800 micrometers, and less than 10 wt % of the agglomerates have a particle size less than 150 micrometers and less than 10 wt % of the agglomerates have a particle size greater than 1200 micrometers.

It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

It may be preferred for ingredients such as polymer and/or non-ionic detersive surfactant and/or perfume to be sprayed onto base detergent particles, such as spray-dried base detergent particles and/or agglomerated base detergent particles. Typically, this spray-on step is carried out in a tumbling drum mixer.

Method of Laundering Fabric: The method of laundering fabric comprises the step of contacting the solid composition to water to form a wash liquor, and laundering fabric in said wash liquor. Typically, the wash liquor has a temperature of above 0° C. to 90° C., or to 60° C., or to 40° C., or to 30° C., or to 20° C. The fabric may be contacted to the water prior to, or after, or simultaneous with, contacting the solid composition with water. Typically, the wash liquor is formed by contacting the laundry detergent to water in such an amount so that the concentration of laundry detergent composition in the wash liquor is from 0.2 g/l to 20 g/l, or from 0.5 g/l to 10 g/l, or to 5.0 g/l. The method of laundering fabric can be carried out in a front-loading automatic washing machine, top loading automatic washing machines, including high efficiency automatic washing machines, or suitable hand-wash vessels. Typically, the wash liquor comprises 90 litres or less, or 60 litres or less, or 15 litres or less, or 10 litres or less of water. Typically, 200 g or less, or 150 g or less, or 100 g or less, or 50 g or less of laundry detergent composition is contacted to water to form the wash liquor.

### Embodiments of the Present Invention

The following are embodiments of the present invention.
1. A method of laundering fabric comprising the steps of:
   (a) contacting a detergent composition comprising:
      (i) detersive surfactant;
      (ii) phenolic antioxidant having the structure

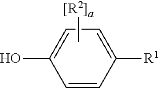

wherein the index a is 1 or 2,
wherein when a is 1, R² is t-butyl and R¹ is —OCH₃,
wherein when a is 2, one R² is t-butyl and the other R² is selected from t-butyl and methyl,
wherein, when a is 2 at least one R² group must be ortho to the hydroxyl group, preferably a t-butyl,
wherein R¹ is selected from the group consisting of methyl, t-butyl, and (C_{b}H_{2b})C(O)R³, where the index b is 2 or 3, preferably 2 wherein R³ is selected from the group consisting of:
(i) OR⁴ where R⁴ is selected from C₁-C₁₈ linear or branched alkyl; —O-Q-O-G, where Q is selected from the group consisting of:
   C₂-C₈ linear or branched alkylene, optionally containing therein one or more ether, thioether or oxamide groups;

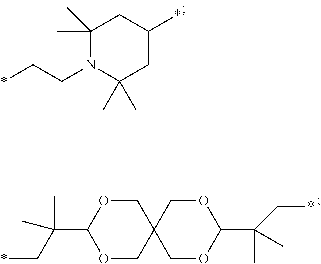 [SMILES: *CCN1C(C)(C)CC(*)CC1(C)C ; *CC(C)(C)C1OCC2(CO1)COC(C(C)(C)C*)OC2]

and
any combination thereof;
(ii)

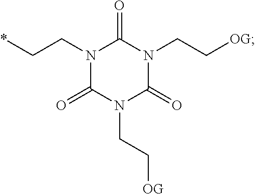

(iii)

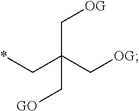

and
(iv) any combination thereof;
wherein each G is independently selected from the group consisting of H and

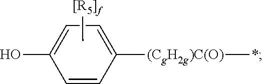

wherein f is 1 or 2,
wherein when f is 1, R⁵ is t-butyl,
wherein when f is 2, one R⁵ is t-butyl and the other R⁵ is selected from t-butyl and methyl,
wherein when f is 2, at least one R⁵ group must be ortho to the hydroxyl group, preferably a t-butyl,
wherein g is 2 or 3, preferably 2,
wherein f, g, and R⁵ are independently selected for each G group;
(iii) percarbonate;
(iv) optionally, a bleach activator capable of forming C₁-C₁₁ alkyl substituted peroxycarboxylic acid; and
(iv) hueing dye,
with water to form a wash liquor comprising from 60 ppm to 2750 ppm detersive surfactant, from 0.1 ppm to 200 ppm phenolic antioxidant, from 10 ppm to 3000 ppm percarbonate, optionally from 2 ppm to 1000 ppm bleach activator, and from 0.005 to 500 pm hueing dye, and from 0.001 ppm to 10.0 ppm iron, and having a pH in the range of from greater than 7.0 to 12.0;
(b) contacting fabric with the wash liquor; and
(c) laundering the fabric.
2. A method according to embodiment 1, wherein the phenolic antioxidant has a structure selected from:

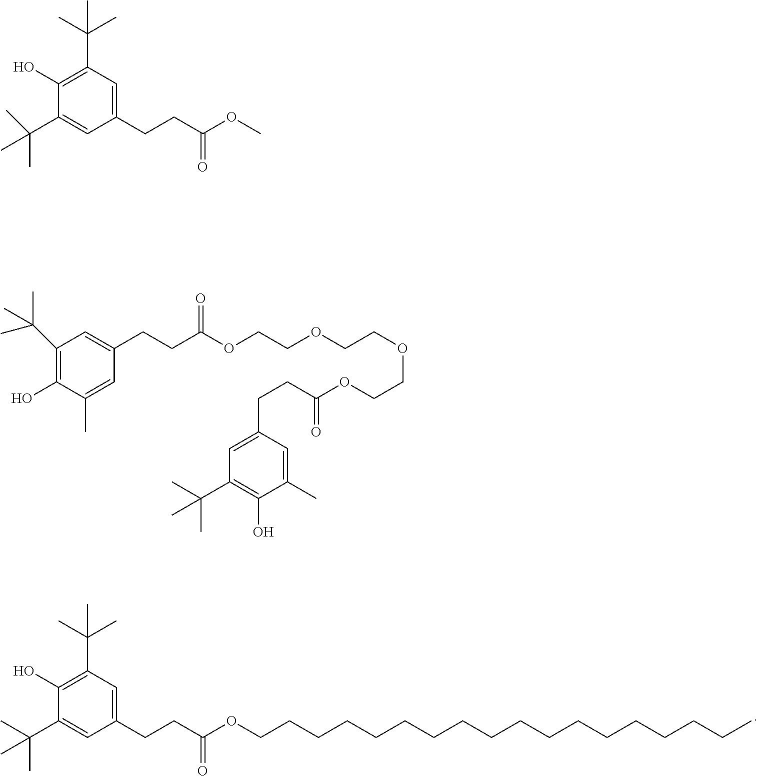 [SMILES: COC(=O)CCc1cc(C(C)(C)C)c(O)c(C(C)(C)C)c1 ; Cc1cc(CCC(=O)OCCOCCOCCOC(=O)CCc2cc(C)c(O)c(C(C)(C)C)c2)cc(C(C)(C)C)c1O ; CCCCCCCCCCCCCCCCCCOC(=O)CCc1cc(C(C)(C)C)c(O)c(C(C)(C)C)c1]

3. A method according to any preceding embodiment, wherein the phenolic antioxidant is octadecyl di-t-butyl-4-hydroxyhydrocinnamate.
4. A method according to any preceding embodiment, wherein the detersive surfactant comprises C₁₂-C₁₄ alkyl sulphate detersive surfactant.
5. A method according to any preceding embodiment, wherein the detergent composition comprises perfume, and wherein the wash liquor comprises from 0.2 ppm to 200 ppm perfume.
6. A method according to any preceding embodiment, wherein the detergent composition comprises enzyme, and wherein the wash liquor comprises from 0.4 ppm to 160 ppm enzyme.
7. A method according to any preceding embodiment, wherein the detergent composition comprises acyl hydrazone bleach catalyst, and wherein the wash liquor comprises from 0.001 ppm to 20 ppm acyl hydrazone bleach catalyst.
8. A method according to any preceding embodiment, wherein the detergent composition comprises imine-based or iminium-based bleach catalyst, and wherein the wash liquor comprises from 0.001 ppm to 20 ppm imine-based or iminium-based bleach catalyst.
9. A method according to any preceding embodiment, wherein the detergent composition comprises a transition metal catalyst, and wherein the wash liquor comprises from 0.001 ppm to 20 ppm transition metal catalyst.
10. A method according to any preceding embodiment, wherein the detergent composition comprises bleach activator selected from tetraacetyl ethylenediamine and/or nonanoyl oxybenzene sulphonate, and wherein the wash liquor comprises from 0.001 ppm to 1600 ppm bleach activator.
11. A method according to any preceding embodiment, wherein the detergent composition comprises pre-formed peracid, preferably phthalimidoperoxycaproic acid, and wherein the wash liquor comprises from 0.001 ppm to 2000 ppm pre-formed peracid.
12. A method according to any preceding embodiment, wherein the detergent composition comprises hueing dye selected from azo dye, azine dye, anthroquinone dye, and any combination thereof, and wherein the wash liquor comprises from 0.001 ppm to 200 ppm hueing dye.

### EXAMPLES

### Example—Bleach Stability

Four powder detergent compositions (Compositions 1 to 4) were made and tested as detailed herein below.

### Test Method

I. Preparation of Test Compositions

Tests were carried out using the following detergent compositions: Material additions shown at active material level in finished product (FP).

| Ingredient | Level (g/100 g FP) | | | | |
|---|---|---|---|---|---|
| Composition | 1 | 2 | 3 | 4 | ppm* |
| 4,4′-bis([4-anilino-6-morpholino- | 0.198 | 0.198 | 0.198 | 0.198 | 9.9 |
| s-triazin-2-yl]-amino)-2,2′- | | | | | |
| stilbenedisulfonate, disodium salt | | | | | |
| Carboxymethyl Cellulose | 0.157 | 0.157 | 0.157 | 0.157 | 7.85 |
| Lipase | 0.008 | 0.008 | 0.008 | 0.008 | 0.4 |
| Mannanase | 0.001 | 0.001 | 0.001 | 0.001 | 0.05 |
| Amylase | 0.003 | 0.003 | 0.003 | 0.003 | 0.15 |
| Suds Supressor | 0.051 | 0.051 | 0.051 | 0.051 | 2.55 |
| Protease | 0.026 | 0.026 | 0.026 | 0.026 | 1.3 |
| Zeolite | 0.251 | 0.251 | 0.251 | 0.251 | 12.55 |
| Phosphodiesterase | 0.003 | 0.003 | 0.003 | 0.003 | 0.15 |
| Sodium 1-hydroxyethyidene-1,1-diphosphonate | 0.404 | 0.404 | 0.404 | 0.404 | 20.2 |
| Carboxylate polymer (such as copolymers of | 0.552 | 0.552 | 0.552 | 0.552 | 27.6 |
| maleic acid and acrylic acid and/or carboxylate | | | | | |
| polymers comprising ether moieties and | | | | | |
| sulfonate moieties) (polymer supplied by | | | | | |
| Nippon Shokubai) | | | | | |
| LAS | 11.656 | 11.656 | 11.656 | 11.656 | 582.8 |
| Trilon ® M | 0.39 | 0.39 | 0.39 | 0.39 | 19.5 |
| C12-C14 Non-ionic Surfactant | 1.8 | 1.8 | 1.8 | 1.8 | 90 |
| Sodium Carbonate | 13.031 | 13.031 | 13.031 | 13.031 | 651.55 |
| Sodium Sulphate | 24.771 | 24.671 | 24.671 | 24.671 | 1233.55 |
| Octadecyl 3-(3,5-di-tert-butyl-4- | 0 | 0.1 | 0 | 0 | 5 |
| hydroxy-phenyl) propionate | | | | | |
| Methyl 3-(3,5-di-tert-butyl-4- | 0 | 0 | 0.1 | 0 | 5 |
| hydroxyphenyl) propanoate | | | | | |
| Butylated Hydroxytoluene | 0 | 0 | 0 | 0.1 | 5 |
| Sodium Chloride | 14.665 | 14.665 | 14.665 | 14.665 | 733.25 |
| Palm stearin | 0.066 | 0.066 | 0.066 | 0.066 | 3.3 |
| Sodium Percarbonate | 13.05 | 13.05 | 13.05 | 13.05 | 652.5 |
| SRA300 | 0.105 | 0.105 | 0.105 | 0.105 | 5.25 |
| Silicate - 1.6R | 6.066 | 6.066 | 6.066 | 6.066 | 303.3 |
| Soap - Palm stearin | 0.131 | 0.131 | 0.131 | 0.131 | 6.55 |
| Tetraacetylethylenediamine | 3.128 | 3.128 | 3.128 | 3.128 | 156.4 |
| Hueing Dye - (BA4 as used in | 0.027 | 0.027 | 0.027 | 0.027 | 1.35 |
| Hueing Dye Stability Example) | | | | | |
| Zeolite | 3.528 | 3.528 | 3.528 | 3.528 | 176.4 |
| Water | 2.082 | 2.082 | 2.082 | 2.082 | 104.1 |
| Processing Aids, minors & perfume | 3.85 | 3.85 | 3.85 | 3.85 | 192.5 |
| Total Parts | 100 | 100 | 100 | 100 | 5000 |

| | | |
|---|---|---|
| Wash Equipment | Tergotometer | Copley |
| Wash Volume | 600 ml | |
| Water Hardness | Deionised water spiked to | |
| | 19.2 gpg hardness and | |
| | 0.0012 ppm Fe³⁺ | |
| Water Temperature | 40° C. | |
| Detergent addition | 3 g | |
| Analytical Equipment | Gallery Automated Chemistry | Thermofisher |
| | Analyzer (Model:861) | Scientific |

### Analysis of Hydrogen Peroxide in Solution

Determination of antioxidant impact on hydrogen peroxide in solution was completed using the following procedure. Four external replicates were completed for each test product. 600 ml of deionised water was measured into each tergotometer pot and heated to 40° C. Water hardness and metal ion content was adjusted to simulate hard water by addition of 1 ml of spike solution to each tergotometer pot which delivered Calcium Chloride Dihydrate (96 mg/L wash solution Ca²⁺), Magnesium Chloride Hexahydrate (21.5 mg/L wash solution Mg²⁺) and Iron Chloride Hexahydrate (0.0012 mg/L wash solution Fe³⁺). 3 g product was then added and a timer started. 1 ml of wash solution was taken from each tergotometer pot at the stated time point using Eppendorf pipette and added to 4 ml 2% Acetic Acid. Wash solution samples were measured for hydrogen peroxide (H₂O₂) by colorimetric assay using Gallery Automated Chemistry Analyzer (Thermofisher Scientific) for reaction between the wash solution and Amplex Red reagent (CAS: 119171-73-2) in the presence of horseradish peroxidase (CAS: 9003-99-0). The measured species is resorufin which is created by reaction of Amplex Red reagent with hydrogen peroxide.

Results below show the measured level of hydrogen peroxide present in tergotometer wash solution at specified time points

| | | ppm H₂O₂ in wash | Standard |
|---|---|---|---|
| | Antioxidant | solution after 30 minutes | Error |
| Composition 1 | Nil | 61.86 | 1.93 |
| Composition 2 | Octadecyl 3-(3,5-di- | 70.26 | 0.99 |
| | tert-butyl-4- | | |
| | hydroxy-phenyl) | | |
| | propionate | | |
| Composition 3 | Methyl 3-(3,5-di- | 68.21 | 1.24 |
| | tert-butyl-4- | | |
| | hydroxyphenyl) | | |
| | propanoate | | |
| Composition 4 | Butylated | 67.60 | 1.56 |
| | Hydroxytoluene | | |

Composition 1 with no antioxidant addition shows lower measured level of hydrogen peroxide in solution after 30 minutes vs compositions with antioxidant present.

Analysis of Peracetic Acid (PAA) in Solution

Determination of antioxidant impact on peracetic acid (PAA) in solution was completed following the same wash procedure as H₂O₂. 1 ml of wash solution was taken from each tergotometer pot using Eppendorf pipette at stated time point and added to 4 ml 2% Acetic Acid. Wash solution samples were measured for PAA by colorimetric assay using Gallery Automated Chemistry Analyzer (Thermofisher Scientific) for reaction between the wash solution and 2,2-Azino-bis(3-ethylbenzothiazoline)-6-sulfonate (ABTS) (CAS: 30931-67-0) in the presence of potassium iodide (KI) (CAS: 7681-11-0). Measured species is ABTS^{•+} radical formed by reaction of ABTS with PAA. This process is greatly accelerated in the presence of KI.

Results below show the measured level of PAA present in tergotometer wash solution at specified time points.

| | | ppm PAA in wash | Standard |
|---|---|---|---|
| | Antioxidant | solution after 40 minutes | Error |
| Composition 1 | Nil | 13.21 | 0.74 |
| Composition 2 | Octadecyl 3- | 30.81 | 2.07 |
| | (3,5-di-tert-butyl- | | |
| | 4-hydroxy-phenyl) | | |
| | propionate | | |
| Composition 3 | Methyl 3- | 27.89 | 0.99 |
| | (3,5-di-tert-butyl-4- | | |
| | hydroxyphenyl) | | |
| | propanoate | | |
| Composition 4 | Butylated | 25.25 | 1.64 |
| | Hydroxytoluene | | |

Composition 1 with no antioxidant addition shows lower measured level of peracetic acid in solution after 30 minutes vs compositions with antioxidant present.

### Example—Hueing Dye Stability

Powder detergent compositions (Compositions 5 to 23) were made and tested as detailed herein below.

### Test Method

I. Preparation of Test Compositions

Tests were carried out using the following detergent compositions: Material additions shown at active material level in finished product (FP).

| | Level (g/100 g FP) | | | | | |
|---|---|---|---|---|---|---|
| | Composition | | | | | |
| Ingredient | 5 | 6 | 7 | 8 | 9 | ppm* |
| 4,4′-bis([4-anilino-6-morpholino- | 0.198 | 0.198 | 0.198 | 0.198 | 0.198 | 9.9 |
| s-triazin-2-yl]-amino)-2,2′- | | | | | | |
| stilbenedisulfonate, disodium salt | | | | | | |
| Carboxymethyl Cellulose | 0.157 | 0.157 | 0.157 | 0.157 | 0.157 | 7.85 |
| Lipase | 0.008 | 0.008 | 0.008 | 0.008 | 0.008 | 0.4 |
| Mannanase | 0.001 | 0.001 | 0.001 | 0.001 | 0.001 | 0.05 |
| Amylase | 0.003 | 0.003 | 0.003 | 0.003 | 0.003 | 0.15 |
| Suds Suppressor | 0.051 | 0.051 | 0.051 | 0.051 | 0.051 | 2.55 |
| Protease | 0.026 | 0.026 | 0.026 | 0.026 | 0.026 | 1.3 |
| Zeolite | 0.251 | 0.251 | 0.251 | 0.251 | 0.251 | 12.55 |
| Phosphodiesterase | 0.003 | 0.003 | 0.003 | 0.003 | 0.003 | 0.15 |
| Sodium 1-hydroxyethyidene-1,1- | 0.404 | 0.404 | 0.404 | 0.404 | 0.404 | 20.2 |
| diphosphonate | | | | | | |
| Carboxylate polymer (such as co- | 0.552 | 0.552 | 0.552 | 0.552 | 0.552 | 27.6 |
| polymers of maleic acid and | | | | | | |
| acrylic acid and/or carboxylate | | | | | | |
| polymers comprising ether | | | | | | |
| moieties and sulfonate moieties) | | | | | | |
| (polymer supplied by Nippon | | | | | | |
| Shokubai) | | | | | | |
| LAS | 11.656 | 11.656 | 11.656 | 11.656 | 11.656 | 582.8 |
| Trilon ® M | 0.390 | 0.390 | 0.390 | 0.390 | 0.390 | 19.5 |
| C12-C14 Non-ionic Surfactant | 1.800 | 1.800 | 1.800 | 1.800 | 1.800 | 90 |
| Sodium Carbonate | 13.031 | 13.031 | 13.031 | 13.031 | 13.031 | 651.55 |
| Sodium Sulphate | 25.000 | 25.000 | 25.000 | 25.000 | 25.000 | 1250 |
| Octadecyl 3-(3,5-di-tert-butyl-4- | 0.000 | 0.100 | 0.000 | 0.000 | 0.000 | 5 |
| hydroxy-phenyl) propionate | | | | | | |
| Methyl 3-(3,5-di-tert-butyl-4- | 0.000 | 0.000 | 0.100 | 0.000 | 0.000 | 5 |
| hydroxyphenyl) propanoate | | | | | | |
| Butylated Hydroxytoluene | 0.000 | 0.000 | 0.000 | 0.100 | 0.000 | 5 |
| Butylated Hydroxyanisole | 0.000 | 0.000 | 0.000 | 0.000 | 0.100 | 5 |
| Sodium Chloride | 14.878 | 14.778 | 14.778 | 14.778 | 14.778 | 738.9 |
| Palm stearin | 0.066 | 0.066 | 0.066 | 0.066 | 0.066 | 3.3 |
| Sodium Percarbonate | 13.05 | 13.05 | 13.05 | 13.05 | 13.05 | 652.5 |
| SRA300 | 0.105 | 0.105 | 0.105 | 0.105 | 0.105 | 5.25 |
| Silicate - 1.6R | 6.066 | 6.066 | 6.066 | 6.066 | 6.066 | 303.3 |
| Soap - Palm stearin | 0.131 | 0.131 | 0.131 | 0.131 | 0.131 | 6.55 |
| Tetraacetylethylenediamine | 3.128 | 3.128 | 3.128 | 3.128 | 3.128 | 156.4 |
| Hueing Dye - Blueing Agent - 1 | 0.163 | 0.163 | 0.163 | 0.163 | 0.163 | 8.15 |
| (BA-1)^{a} | | | | | | |
| Zeolite | 3.528 | 3.528 | 3.528 | 3.528 | 3.528 | 176.4 |
| Water | 2.082 | 2.082 | 2.082 | 2.082 | 2.082 | 104.1 |
| Processing Aids, minors & | 3.272 | 3.272 | 3.272 | 3.272 | 3.272 | 163.6 |
| perfume | | | | | | |
| Total Parts | 100.000 | 100.000 | 100.000 | 100.000 | 100.000 | 5000 |

^{a}α-[4-[[[4-[2-[4-[2-[1-hydroxy-6-(phenylamino)-3-sulfo-2-naphthalenyl]diazenyl]-5-methoxy-2-methylphenyl]diazenyl]phenyl]sulfonyl]amino]phenyl]-ω-hydroxy-poly(oxy-1,2-ethanediyl), sodium salt (1:1); average degree of ethoxylation about 10.

| Ingredient | Level (g/100 g FP) | | | | |
|---|---|---|---|---|---|
| Composition | 10 | 11 | 12 | 13 | ppm* |
| 4,4′-bis([4-anilino-6-morpholino-s-triazin-2- | 0.198 | 0.198 | 0.198 | 0.198 | 9.9 |
| yl]-amino)-2,2′-stilbenedisulfonate, disodium salt | | | | | |
| Carboxymethyl Cellulose | 0.157 | 0.157 | 0.157 | 0.157 | 7.85 |
| Lipase | 0.008 | 0.008 | 0.008 | 0.008 | 0.4 |
| Mannanase | 0.001 | 0.001 | 0.001 | 0.001 | 0.05 |
| Amylase | 0.003 | 0.003 | 0.003 | 0.003 | 0.15 |
| Suds Suppressor | 0.051 | 0.051 | 0.051 | 0.051 | 2.55 |
| Protease | 0.026 | 0.026 | 0.026 | 0.026 | 1.3 |
| Zeolite | 0.251 | 0.251 | 0.251 | 0.251 | 12.55 |
| Phosphodiesterase | 0.003 | 0.003 | 0.003 | 0.003 | 0.15 |
| Sodium 1-hydroxyethyidene-1,1-diphosphonate | 0.404 | 0.404 | 0.404 | 0.404 | 20.2 |
| Carboxylate polymer (such as copolymers of | 0.552 | 0.552 | 0.552 | 0.552 | 27.6 |
| maleic acid and acrylic acid and/or carboxylate | | | | | |
| polymers comprising ether moieties and sulfonate | | | | | |
| moieties) (polymer supplied by Nippon Shokubai) | | | | | |
| LAS | 11.656 | 11.656 | 11.656 | 11.656 | 582.8 |
| Trilon ® M | 0.390 | 0.390 | 0.390 | 0.390 | 19.5 |
| C12-C14 Non-ionic Surfactant | 1.800 | 1.800 | 1.800 | 1.800 | 90 |
| Sodium Carbonate | 13.031 | 13.031 | 13.031 | 13.031 | 651.55 |
| Sodium Sulphate | 25.000 | 25.000 | 25.000 | 25.000 | 1250 |
| Octadecyl 3-(3,5-di-tert-butyl-4-hydroxy-phenyl) | 0.000 | 0.100 | 0.000 | 0.000 | 5 |
| propionate | | | | | |
| Methyl 3-(3,5-di-tert-butyl-4-hydroxyphenyl) | 0.000 | 0.000 | 0.100 | 0.000 | 5 |
| propanoate | | | | | |
| Butylated Hydroxyanisole | 0.000 | 0.000 | 0.000 | 0.100 | 5 |
| Sodium Chloride | 14.878 | 14.778 | 14.778 | 14.778 | 738.9 |
| Palm stearin | 0.066 | 0.066 | 0.066 | 0.066 | 3.3 |
| Sodium Percarbonate | 13.050 | 13.050 | 13.050 | 13.050 | 652.5 |
| SRA300 | 0.105 | 0.105 | 0.105 | 0.105 | 5.25 |
| Silicate - 1.6R | 6.066 | 6.066 | 6.066 | 6.066 | 303.3 |
| Soap - Palm stearin | 0.131 | 0.131 | 0.131 | 0.131 | 6.55 |
| Tetraacetylethylenediamine | 3.128 | 3.128 | 3.128 | 3.128 | 156.4 |
| Hueing Dye -Blueing Agent 2 (BA-2)^{b} | 0.163 | 0.163 | 0.163 | 0.163 | 8.15 |
| Zeolite | 3.528 | 3.528 | 3.528 | 3.528 | 176.4 |
| Water | 2.082 | 2.082 | 2.082 | 2.082 | 104.1 |
| Processing Aids, minors & perfume | 3.272 | 3.272 | 3.272 | 3.272 | 163.6 |
| Total Parts | 100.000 | 100.000 | 100.000 | 100.000 | 5000 |

^{b}4-hydroxy-3-[2-[2-methoxy-5-methyl-4-[2-(4-sulfophenyl)diazenyl]phenyl]diazenyl]-7-(phenylamino)-2-naphthalenesulfonic acid, sodium salt (1:2).

| | Level (g/100 g FP) | | | | | |
|---|---|---|---|---|---|---|
| | Composition | | | | | |
| Ingredient | 14 | 15 | 16 | 17 | 18 | ppm* |
| 4,4′-bis([4-anilino-6-morpholino- | 0.198 | 0.198 | 0.198 | 0.198 | 0.198 | 9.9 |
| s-triazin-2-yl]-amino)-2,2′- | | | | | | |
| stilbenedisulfonate, disodium salt | | | | | | |
| Carboxymethyl Cellulose | 0.157 | 0.157 | 0.157 | 0.157 | 0.157 | 7.85 |
| Lipase | 0.008 | 0.008 | 0.008 | 0.008 | 0.008 | 0.4 |
| Mannanase | 0.001 | 0.001 | 0.001 | 0.001 | 0.001 | 0.05 |
| Amylase | 0.003 | 0.003 | 0.003 | 0.003 | 0.003 | 0.15 |
| Suds Suppressor | 0.051 | 0.051 | 0.051 | 0.051 | 0.051 | 2.55 |
| Protease | 0.026 | 0.026 | 0.026 | 0.026 | 0.026 | 1.3 |
| Zeolite | 0.251 | 0.251 | 0.251 | 0.251 | 0.251 | 12.55 |
| Phosphodiesterase | 0.003 | 0.003 | 0.003 | 0.003 | 0.003 | 0.15 |
| Sodium 1-hydroxyethyidene-1,1- | 0.404 | 0.404 | 0.404 | 0.404 | 0.404 | 20.2 |
| diphosphonate | | | | | | |
| Carboxylate polymer (such as co- | 0.552 | 0.552 | 0.552 | 0.552 | 0.552 | 27.6 |
| polymers of maleic acid and | | | | | | |
| acrylic acid and/or carboxylate | | | | | | |
| polymers comprising ether | | | | | | |
| moieties and sulfonate moieties) | | | | | | |
| (polymer supplied by Nippon | | | | | | |
| Shokubai) | | | | | | |
| LAS | 11.656 | 11.656 | 11.656 | 11.656 | 11.656 | 582.8 |
| Trilon ® M | 0.390 | 0.390 | 0.390 | 0.390 | 0.390 | 19.5 |
| C12-C14 Non-ionic Surfactant | 1.800 | 1.800 | 1.800 | 1.800 | 1.800 | 90 |
| Sodium Carbonate | 13.031 | 13.031 | 13.031 | 13.031 | 13.031 | 651.55 |
| Sodium Sulphate | 25.000 | 25.000 | 25.000 | 25.000 | 25.000 | 1250 |
| Octadecyl 3-(3,5-di-tert-butyl-4- | 0.000 | 0.100 | 0.000 | 0.000 | 0.000 | 5 |
| hydroxy-phenyl) propionate | | | | | | |
| Methyl 3-(3,5-di-tert-butyl-4- | 0.000 | 0.000 | 0.100 | 0.000 | 0.000 | 5 |
| hydroxyphenyl) propanoate | | | | | | |
| Butylated Hydroxytoluene | 0.000 | 0.000 | 0.000 | 0.100 | 0.000 | 5 |
| Butylated Hydroxyanisole | 0.000 | 0.000 | 0.000 | 0.000 | 0.100 | 5 |
| Sodium Chloride | 14.878 | 14.778 | 14.778 | 14.778 | 14.778 | 738.9 |
| Palm stearin | 0.066 | 0.066 | 0.066 | 0.066 | 0.066 | 3.3 |
| Sodium Percarbonate | 13.050 | 13.050 | 13.050 | 13.050 | 13.050 | 652.5 |
| SRA300 | 0.105 | 0.105 | 0.105 | 0.105 | 0.105 | 5.25 |
| Silicate - 1.6R | 6.066 | 6.066 | 6.066 | 6.066 | 6.066 | 303.3 |
| Soap - Palm stearin | 0.131 | 0.131 | 0.131 | 0.131 | 0.131 | 6.55 |
| Tetraacetylethylenediamine | 3.128 | 3.128 | 3.128 | 3.128 | 3.128 | 156.4 |
| Hueing Dye - Blueing Agent 3 | 0.163 | 0.163 | 0.163 | 0.163 | 0.163 | 8.15 |
| (BA-3)^{c} | | | | | | |
| Zeolite | 3.528 | 3.528 | 3.528 | 3.528 | 3.528 | 176.4 |
| Water | 2.082 | 2.082 | 2.082 | 2.082 | 2.082 | 104.1 |
| Processing Aids, minors & | 3.272 | 3.272 | 3.272 | 3.272 | 3.272 | 163.6 |
| perfume | | | | | | |
| Total Parts | 100.000 | 100.000 | 100.000 | 100.000 | 100.000 | 5000 |

^{c}9-amino-11-methoxy-7-phenyl-5-(phenylamino)-4,8-disulfo-benzo[a]phenazinium, inner salt, sodium salt (1:1).

| | Level (g/100 g FP) | | | | | |
|---|---|---|---|---|---|---|
| | Composition | | | | | |
| Ingredient | 19 | 20 | 21 | 22 | 23 | ppm * |
| 4,4′-bis([4-anilino-6-morpholino- | 0.198 | 0.198 | 0.198 | 0.198 | 0.198 | 9.9 |
| s-triazin-2-yl]-amino)-2,2′- | | | | | | |
| stilbenedisulfonate, disodium salt | | | | | | |
| Carboxymethyl Cellulose | 0.157 | 0.157 | 0.157 | 0.157 | 0.157 | 7.85 |
| Lipase | 0.008 | 0.008 | 0.008 | 0.008 | 0.008 | 0.4 |
| Mannanase | 0.001 | 0.001 | 0.001 | 0.001 | 0.001 | 0.05 |
| Amylase | 0.003 | 0.003 | 0.003 | 0.003 | 0.003 | 0.15 |
| Suds Suppressor | 0.051 | 0.051 | 0.051 | 0.051 | 0.051 | 2.55 |
| Protease | 0.026 | 0.026 | 0.026 | 0.026 | 0.026 | 1.3 |
| Zeolite | 0.251 | 0.251 | 0.251 | 0.251 | 0.251 | 12.55 |
| Phosphodiesterase | 0.003 | 0.003 | 0.003 | 0.003 | 0.003 | 0.15 |
| Sodium 1-hydroxyethyidene-1,1- | 0.404 | 0.404 | 0.404 | 0.404 | 0.404 | 20.2 |
| diphosphonate | | | | | | |
| Carboxylate polymer (such as co- | 0.552 | 0.552 | 0.552 | 0.552 | 0.552 | 27.6 |
| polymers of maleic acid and | | | | | | |
| acrylic acid and/or carboxylate | | | | | | |
| polymers comprising ether | | | | | | |
| moieties and sulfonate moieties) | | | | | | |
| (polymer supplied by Nippon | | | | | | |
| Shokubai) | | | | | | |
| LAS | 11.656 | 11.656 | 11.656 | 11.656 | 11.656 | 582.8 |
| Trilon ® M | 0.390 | 0.390 | 0.390 | 0.390 | 0.390 | 19.5 |
| C12-C14 Non-ionic Surfactant | 1.800 | 1.800 | 1.800 | 1.800 | 1.800 | 90 |
| Sodium Carbonate | 13.031 | 13.031 | 13.031 | 13.031 | 13.031 | 651.55 |
| Sodium Sulphate | 25.000 | 25.000 | 25.000 | 25.000 | 25.000 | 1250 |
| Octadecyl 3-(3,5-di-tert-butyl-4- | 0.000 | 0.100 | 0.000 | 0.000 | 0.000 | 5 |
| hydroxy-phenyl) propionate | | | | | | |
| Methyl 3-(3,5-di-tert-butyl-4- | 0.000 | 0.000 | 0.100 | 0.000 | 0.000 | 5 |
| hydroxyphenyl) propanoate | | | | | | |
| Butylated Hydroxytoluene | 0.000 | 0.000 | 0.000 | 0.100 | 0.000 | 5 |
| Butylated Hydroxyanisole | 0.000 | 0.000 | 0.000 | 0.000 | 0.100 | 5 |
| Sodium Chloride | 14.878 | 14.778 | 14.778 | 14.778 | 14.778 | 738.9 |
| Palm stearin | 0.066 | 0.066 | 0.066 | 0.066 | 0.066 | 3.3 |
| Sodium Percarbonate | 13.050 | 13.050 | 13.050 | 13.050 | 13.050 | 652.5 |
| SRA300 | 0.105 | 0.105 | 0.105 | 0.105 | 0.105 | 5.25 |
| Silicate - 1.6R | 6.066 | 6.066 | 6.066 | 6.066 | 6.066 | 303.3 |
| Soap - Palm stearin | 0.131 | 0.131 | 0.131 | 0.131 | 0.131 | 6.55 |
| Tetraacetylethylenediamine | 3.128 | 3.128 | 3.128 | 3.128 | 3.128 | 156.4 |
| Hueing Dye - Blueing Agent 4 | 0.163 | 0.163 | 0.163 | 0.163 | 0.163 | 8.15 |
| (BA-4)^{d} | | | | | | |
| Zeolite | 3.528 | 3.528 | 3.528 | 3.528 | 3.528 | 176.4 |
| Water | 2.082 | 2.082 | 2.082 | 2.082 | 2.082 | 104.1 |
| Processing Aids, minors & | 3.272 | 3.272 | 3.272 | 3.272 | 3.272 | 163.6 |
| perfume | | | | | | |
| Total Parts | 100.000 | 100.000 | 100.000 | 100.000 | 100.000 | 5000 |

^{d}α,α′-[[[4-[2-(3,5-dicyano-4-methyl-2-thienyl)diazenyl]-3-methylphenyl]imino]di-2,1-ethanediyl]bis[ω-hydroxy-poly(oxy-1,2-ethanediyl)]; average degree of ethoxylation about 5.
*ppm where present.

II. Test Procedure

| | | |
|---|---|---|
| Wash Equipment | Tergotometer | Copley |
| Wash Volume | 600 ml | |
| Water Hardness | Deionised water spiked to 19.2 gpg | |
| | hardness and 0.0012 ppm Fe³⁺ | |
| Water Temperature | 40° C. | |
| Detergent addition | 3 g | |
| Analytical Equipment | Tecan Spectrophotometer | TECAN |
| | (model: Spark 10M) | |

Determination of Antioxidant Impact on of Hueing Dye Concentration in Solution

Determination of antioxidant impact on hueing dye concentration in solution was completed using the following procedure. 600 ml of deionised water was measured into each tergotometer pot and heated to 40° C. 3 g product was added and allowed to dissolve. 2 ml of wash solution was taken from each tergotometer pot using Eppendorf pipette and added to 24 well plate. Absorbance of wash solution samples was measured between 500 and 600 nm with peak positions depending on hueing dyes by spectrophotometer to determine T=0 absorbance. Water hardness and metal ion content was then adjusted to simulate hard water by addition of 1 ml of spike solution to each tergotometer pot which delivers Calcium Chloride Dihydrate (96 mg/L wash solution Ca²⁺), Magnesium Chloride Hexahydrate (21.5 mg/L wash solution Mg²⁺) and Iron Chloride Hexahydrate (0.0012 mg/L wash solution Fe³⁺) and timer started. 2 ml of wash solution was taken from each tergotometer pot using Eppendorf pipette and added to 24 well plate at stated time point and measured by Tecan Spectrophotometer (model: Spark 10M) to determine delta abs vs T=0.

| | | Indexed Percentage |
|---|---|---|
| | | reduction in absorbance |
| Product (BA-1) | Antioxidant | (542 nm) after 5 minutes |
| Composition 5 | Nil | 100 |
| Composition 6 | Octadecyl 3-(3,5-di-tert-butyl-4- | 29.8 |
| | hydroxy-phenyl) propionate | |
| Composition 7 | Methyl 3-(3,5-di-tert-butyl-4- | 42.2 |
| | hydroxyphenyl) propanoate | |
| Composition 8 | Butylated Hydroxytoluene | 41.3 |
| Composition 9 | Butylated Hydroxyanisole | 39.9 |

Composition 5 with no antioxidant addition shows greater reduction in absorbance, showing lower remaining concentration of hueing dye after 5 minutes vs compositions 6-9 with antioxidant present.

| | | Indexed Percentage |
|---|---|---|
| | | reduction in absorbance |
| | | (542 nm) after |
| Product (BA-2) | Antioxidant | 10 minutes |
| Composition 10 | Nil | 100 |
| Composition 11 | Octadecyl 3-(3,5-di-tert-butyl-4- | 85.4 |
| | hydroxy-phenyl) propionate | |
| Composition 12 | Methyl 3-(3,5-di-tert-butyl-4- | 75.6 |
| | hydroxyphenyl) propanoate | |
| Composition 13 | Butylated Hydroxyanisole | 78.8 |

Composition 10 with no antioxidant addition shows greater reduction in absorbance, showing lower remaining concentration of hueing dye after 10 minutes vs compositions 11-13 with antioxidant present

| | | Indexed Percentage |
|---|---|---|
| | | reduction in absorbance |
| Product (BA-3) | Antioxidant | (556 nm) after 5 minutes |
| Composition 14 | Nil | 100 |
| Composition 15 | Octadecyl 3-(3,5-di-tert-butyl-4- | 66.5 |
| | hydroxy-phenyl) propionate | |
| Composition 16 | Methyl 3-(3,5-di-tert-butyl-4- | 9.9 |
| | hydroxyphenyl) propanoate | |
| Composition 17 | Butylated Hydroxytoluene | 13.6 |
| Composition 18 | Butylated Hydroxyanisole | 50.6 |

Composition 14 with no antioxidant addition shows greater reduction in absorbance, showing lower remaining concentration of hueing dye after 5 minutes vs compositions 15-19 with antioxidant present.

| | | Indexed Percentage |
|---|---|---|
| | | reduction in absorbance |
| Product (BA-4) | Antioxidant | (570 nm) after 5 minutes |
| Composition 19 | Nil | 100 |
| Composition 20 | Octadecyl 3-(3,5-di-tert-butyl-4- | 58.7 |
| | hydroxy-phenyl) propionate | |
| Composition 21 | Methyl 3-(3,5-di-tert-butyl-4- | 87.5 |
| | hydroxyphenyl) propanoate | |
| Composition 22 | Butylated Hydroxytoluene | 79.2 |
| Composition 23 | Butylated Hydroxyanisole | 50.1 |

Composition 19 with no antioxidant addition shows greater reduction in absorbance, showing lower remaining concentration of hueing dye after 5 minutes vs compositions 20-23 with antioxidant present.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of laundering fabric comprising the steps of:
(a) contacting a detergent composition comprising:
(i) detersive surfactant;
(ii) phenolic antioxidant having the structure 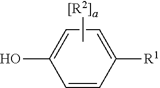
wherein the index a is about 1 or about 2,
wherein when a is about 1, R² is t-butyl and R¹ is —OCH₃,
wherein when a is about 2, one R² is t-butyl and the other R² is selected from t-butyl and methyl,
wherein, when a is about 2 at least one R² group must be ortho to the hydroxyl group,
wherein R¹ is selected from the group consisting of methyl, t-butyl, and (C_{b}H_{2b})C(O)R³, where the index b is about 2 or about 3,
wherein R³ is selected from the group consisting of:
(i) OR⁴ where R⁴ is selected from C₁-C₁₈ linear or branched alkyl; —O-Q-O-G, where Q is selected from the group consisting of:
C₂-C₈ linear or branched alkylene, optionally containing therein one or more ether, thioether or oxamide groups; 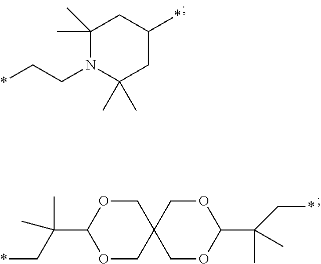 [SMILES: *CCN1C(C)(C)CC(*)CC1(C)C ; *CC(C)(C)C1OCC2(CO1)COC(C(C)(C)C*)OC2]
and
any combination thereof;
(ii) 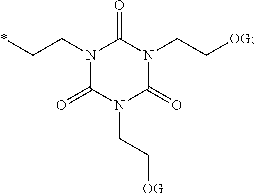
(iii) 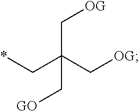
and
(iv) any combination thereof;
wherein each G is independently selected from the group consisting of H and 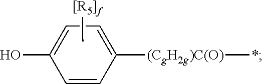
wherein f is about 1 or about 2,
wherein when f is about 1, R⁵ is t-butyl,
wherein when f is about 2, one R⁵ is t-butyl and the other R⁵ is selected from t-butyl and methyl,
wherein when f is about 2, at least one R⁵ group must be ortho to the hydroxyl group,
wherein g is about 2 or about 3,
wherein f, g, and R⁵ are independently selected for each G group;
(iii) percarbonate; and
(iv) hueing dye,
with water to form a wash liquor comprising from about 60 ppm to about 2750 ppm detersive surfactant, from about 0.1 ppm to about 200 ppm phenolic antioxidant, from about 10 ppm to about 3000 ppm percarbonate, and from about 0.005 to about 500 pm hueing dye, and from about 0.001 ppm to about 10.0 ppm iron, and having a pH in the range of from greater than about 7.0 to about 12.0;
(b) contacting fabric with the wash liquor; and
(c) laundering the fabric.

2. The method according to claim 1, wherein the phenolic antioxidant has a structure selected from:

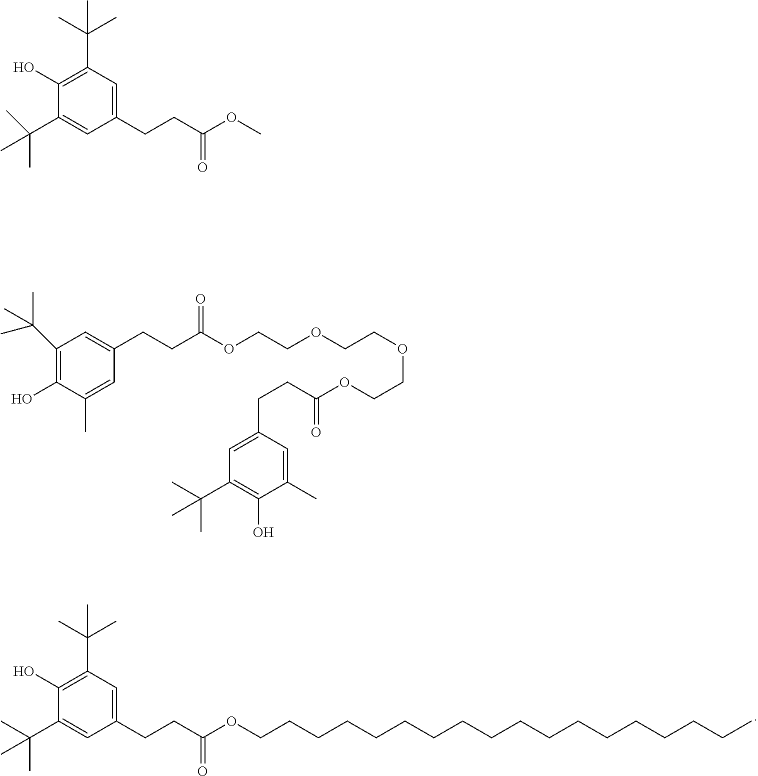 [SMILES: COC(=O)CCc1cc(C(C)(C)C)c(O)c(C(C)(C)C)c1 ; Cc1cc(CCC(=O)OCCOCCOCCOC(=O)CCc2cc(C)c(O)c(C(C)(C)C)c2)cc(C(C)(C)C)c1O ; CCCCCCCCCCCCCCCCCCOC(=O)CCc1cc(C(C)(C)C)c(O)c(C(C)(C)C)c1]

3. The method according to claim 1, wherein the phenolic antioxidant is octadecyl di-t-butyl-4-hydroxyhydrocinnamate.

4. The method according to claim 1, wherein the detersive surfactant comprises C₁₂-C₁₄ alkyl sulphate detersive surfactant.

5. The method according to claim 1, wherein the detergent composition comprises perfume, and wherein the wash liquor comprises from about 0.2 ppm to about 200 ppm perfume.

6. The method according to claim 1, wherein the detergent composition comprises enzyme, and wherein the wash liquor comprises from about 0.4 ppm to about 160 ppm enzyme.

7. The method according to claim 1, wherein the detergent composition comprises acyl hydrazone bleach catalyst, and wherein the wash liquor comprises from about 0.001 ppm to about 20 ppm acyl hydrazone bleach catalyst.

8. The method according to claim 1, wherein the detergent composition comprises imine-based or iminium-based bleach catalyst, and wherein the wash liquor comprises from about 0.001 ppm to about 20 ppm imine-based or iminium-based bleach catalyst.

9. The method according to claim 1, wherein the detergent composition comprises a transition metal catalyst, and wherein the wash liquor comprises from about 0.001 ppm to about 20 ppm transition metal catalyst.

10. The method according to claim 1, wherein the detergent composition comprises bleach activator selected from tetraacetyl ethylenediamine and/or nonanoyl oxybenzene sulphonate, and wherein the wash liquor comprises from about 0.001 ppm to about 1600 ppm bleach activator.

11. The method according to claim 1, wherein the detergent composition comprises pre-formed peracid, and wherein the wash liquor comprises from about 0.001 ppm to about 2000 ppm pre-formed peracid.

12. The method according to claim 1, wherein the detergent composition comprises hueing dye selected from azo dye, azine dye, anthroquinone dye, and any combination thereof, and wherein the wash liquor comprises from about 0.001 ppm to about 200 ppm hueing dye.

13. The method according to claim 1, wherein the detergent composition further comprises a bleach activator capable of forming C₁-C₁₁ alkyl substituted peroxycarboxylic acid.
